(19) United States
(12) Patent Application Publication
(10) Pub. No.: US 2005/0013018 A1
(43) Pub. Date: Jan. 20, 2005

(54) Compact lens assembly

(76) Inventor: Alex Ning, San Marcos, CA (US)

Correspondence Address: JAMES F. KIRK, 16365 MARUFFA CIRCLE, HUNTINGTON BEACH, CA, 92649-2134, US

(21) Appl. No.: 10/620,676

(22) Filed: Jul. 16, 2003

(51) Int. Cl. G02B 9/12

(52) U.S. Cl. 359/784

(57) ABSTRACT

An lens assembly has a having a height TT and a focal length f0 and three lens elements with first and second surfaces, the first surface of each element facing the object. The first lens element has a positive power and a focal length f1. The second lens element 20 is a aspheric lens, the first surface being concave and facing the first lens element second surface. The second lens element second surface being an aspheric surface. The third lens element first surface is convex having a radius of r1 and the second surface having a radius r2 with |r2|>|r1|. The first, second and third lens elements are shaped are formed to obtain a ratio of f1/f0 in the range of 0.5 to 2.0 and a TT/DI<1.5. The elements are formed and spaced to obtain an image with a maximum effective dimension DI on an image plane in a digital camera.

### FIELD OF THE INVENTION

This invention relates to compact lenses for digital camera applications; in particular, for very compact digital cameras such as could be incorporated into a cellular telephone, personal digital assistant, or other very small electronic device.

### BACKGROUND OF THE INVENTION

Digital cameras utilizing high-resolution electronic imaging sensors require high resolution optics. For the consumer market, it is important that the lenses can be produced in high volume inexpensively. For use in very compact digital cameras, and cameras that might be incorporated into devices such as palm-sized computers, cellular telephones and the like, the lens must be very compact. In particular, it must have a very short length from the lens front surface to the image plane.

In the prior art, high resolution lenses have generally been made up of several individual lens elements in order to balance the inherent optical aberrations. These lenses that require a large number of elements tend to be relatively large, heavy, and expensive to manufacture. (The cost of these lenses increases with the number of elements, also resulting in increased costs in assembling and mounting them in a lens cell.) Prior lenses are generally designed using all spherical surfaces or using at least some aspheric elements in which one or both surfaces are aspherical. Where all elements have spherical surfaces, generally a high number of lens elements is required, making the lens long and expensive to produce.

Aspherical lenses have some optical advantages, but cannot be easily produced by traditional glass grinding and polishing techniques. Aspheric elements are typically produced by molding plastics or low melt temperature glasses. While molded plastic elements are inexpensive to produce, the level of precision of the lenses is not always sufficient for high-resolution cameras, especially if a plastic element is used primarily as a focusing element. In addition, the optical properties of most plastic materials change with changes in temperature and humidity. The index of refraction of the plastic lens materials changes with changes in temperature, such as going in and out of doors on very hot or very cold days. This change is a significant problem with the focusing element(s), but is of much less consequence with other elements which primarily correct for aberrations. Lenses with all glass elements can overcome this problem, but tend to be large and excessively expensive for use in compact digital cameras used in other devices, such as an accessory built into a cellular phone.

In U.S. Pat. No. 6,441,971, the same inventor describes a three-element objective lens. The third lens element is shown as an aspheric plastic element. However this design has limited image quality which makes it unsuitable for high-resolution imagers with pixel counts greater than 1 million known as megapixel imagers. A separate infrared cut-off (IR) filter is also required. This makes this design more expensive to manufacture.

Therefore, there is a continuing need for improved lenses that have excellent optical performance and are compact, short, light weight and inexpensive to produce while using conventional, well-proven manufacturing methods.

### SUMMARY OF THE INVENTION

The above-noted problems, and others, are overcome in accordance with this invention by a lens for digital cameras; in particular, such cameras that are incorporated into another device such as a cell phone, personal digital assistant and the like, that is extremely compact and has a short length from the front element surface to the imaging plane, have three lens elements having excellent optical characteristics.

The lens comprises three lens elements. The first, or front, lens element has positive optical power with the first surface be convex. The second lens element 20 is an aspheric element with anaspheric surface facing the image plane. The third lens element has a convex first surface, and a substantially flat second surface (defined as the absolute radius of second surface is greater that of the first surface). Aspherical elements have at least one surface being a non-spherical surface. An electronic imaging sensor is spaced at a suitable distance from the third lens element.

In the preferred embodiment, an IR cut-off coating is also applied to the second surface of the third lens element to produce an integrated imaging lens with IR cut-off function. This eliminates the need for a separate IR cut-off filter in addition to the lens, thus making the entire optical assembly less costly to manufacture.

In the preferred embodiment, the first lens element is also made of glass material. The use of a glass front element greatly reduces lens temperature sensitivity when the lens is taken from areas at great temperature differences, such as when bringing a camera into a building on a hot summer day or cold winter day.

It is, therefore, an object of this invention to provide a compact lens assembly particularly suitable for use in high resolution compact digital cameras with megapixel imagers, especially those incorporated into other compact electronic devices such as cellular phones, personal digital assistants and the like.

Another object of this invention is to provide a lens assembly for digital cameras that has very low sensitivity to changes in temperature.

A further object is to provide a digital camera lens having an extremely short length from the front surface of the lens to the sensor imaging plane.

Yet another object is to provide a digital camera lens having an integrated IR cut-off coating to provide an optimum combination of imaging quality, small F-stop, and low manufacturing cost.

### BRIEF DESCRIPTION OF THE DRAWINGS

Details of the invention, and of preferred embodiments thereof, will be further understood upon reference to the drawing, wherein:

FIG. 1 is a schematic side view showing, in sequence, first, second and third lens elements aligned on the optical axis from left to right with an object on the left and an electronic imager being shown at the right.

### DETAILED DESCRIPTION OF PREFERRED EMBODIMENTS

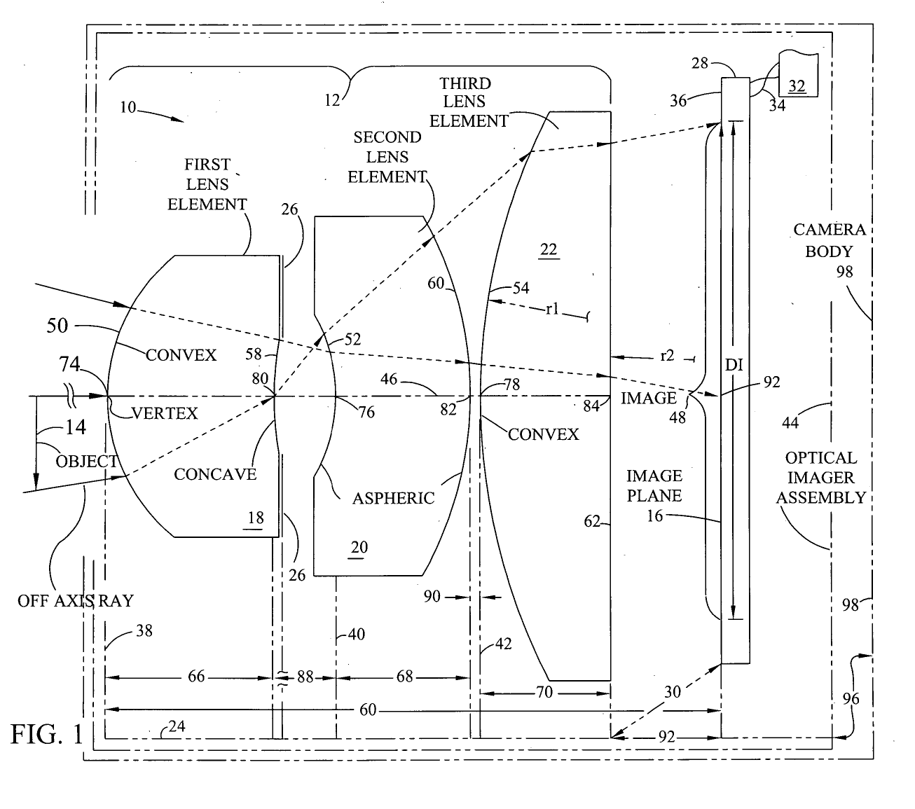

FIG. 1 shows the invention lens assembly 10 positioned under bracket 12 for forming the image of an object 14 on image plane 16. The lens assembly 10 comprises a first lens element 18, a second lens element 20 and a third lens element 22, each of which are coupled together and held in optical alignment by a lens frame or housing represented by phantom line 24. An aperture stop 26 is positioned between the first and second lens elements 18, 20.

An electronic imager 28 (either a CCD or CMOS imager) such as the Sony ICX098 CCD imager is represented by an elongated block at the right. The electronic imager 28 is coupled to and held in alignment with the lens assembly 10 by a first attachment link 30 to the lens frame or housing 24. Operation of the electronic imager 28 is supported by a camera electronics and a processor 32. Signal leads 34 schematically represent the cabling necessary to carry image signals, control levels and power from the electronic imager 28 to the camera electronics and processor 32.

The electronic imager 28 has an active surface 36. The active surface 36 is typically a window region on a surface of the image plane 14 of the electronic imager 28. The active surface may be covered by a glass or other transparent cover (not shown) to reduce the sensitivity of the electronic imager 28 to environmental effects. The three lens elements are coupled schematically to the lens frame or housing 24 via second, third and fourth attachment links represented by phantom lines 38, 40, 42, 92 from the first vertex of each respective lens element to lens frame or housing 24 to form the lens assembly 10 under bracket 12. An optical imager assembly 44 is formed by the combination of the lens assembly 10 with the electronic imager by the first attachment link 30.

The first, second and third lens elements 18, 20, 22 are coaxially aligned along optical axis 46. The optical axis 46 is normal to or perpendicular to the image plane 14.

Bracket 48 schematically represents the maximum diameter of an image formed on the active surface 36 or, in the alternative, the diagonal dimension, DI of the active surface 36 on the electronic imager 28.

The lens assembly 10 is a three element objective lens assembly. The lens assembly 10 has a focal length f0. Each respective lens element 18, 20 and 22 has a first and second surface. The three first surfaces 50, 52, 54 face to the left in the direction of the object 12. The three second surfaces 42, 44, and 46 face to the right in the direction of the image plane 14.

First lens element 18 has a focal length f1 that is greater than zero (f1>0) therefore the first lens element 18 has a positive power. The first lens element first surface 50 is convex in shape. The first lens element second surface 58 is concave in shape. The second lens element first surface 52 has a concave shape. The second lens element second surface 60 has an aspheric shape. In an alternative embodiment, the second lens element first and second surfaces 52, 60 will both be aspheric in shape for optimum results. The third lens element 22 first surface 54 has a convex shape. The third lens element second surface 62 is substantially flat. If the radius of the third lens element first surface is r1 and the third lens element second surface radius is r2 then the second surface is considered to be substantially flat if |r2|>|r1|. If the first or second surface is aspheric, the respective radius r1 or r2 represents the best fit spherical radius to the aspheric profile.

A phantom line extending vertically from the aperture stop 26 schematically locates and represents the aperture stop plane positioned close to the second surface of the first lens element 18. A conventional fixed aperture stop 26, or a variable aperture stop and a shutter may be provided as desired at the aperture stop plane. In the absence of a shutter, the imager is electronically operated gated on to provide the desired exposure length.

The objective lens system has a height TT shown as dimension 60 at the bottom of FIG. 1. The height or length of the objective TT is shown to be equal to the sum of the thickness of the first, second and third lens elements characterized as dimensions 66, 68, and 70 along the base of the lens frame or housing 24. Each of the respective lens thicknesses are measured as the distance between the first and second vertex of each respective lens element. The three thicknesses are then added to a first and second lens separation distance 88, the distance between the first lens element second vertex and the second lens element first vertex. The resulting sum is then added to a second lens separation distance 90; the distance between the second lens element second vertex and the third lens element first vertex. The resulting sum is then added to the image plane distance 92, the separation between the third lens element second vertex and center of the image plane 94.

The lens assembly frame or housing 24 is aligned with and coupled to the electronic imager 28 to form an optical imager assembly 44. The optical imager assembly 44 is then connected to the camera electronics and processor 32 via signal leads 34. The optical imager assembly 44 is then coupled and assembled via a fifth link, the imager assembly link 96 into a camera body 98 for use with a digital camera (not shown) . . . The term link is used to indicate a mechanical coupling during or after alignment and assembly by conventional assembly means such as screwing or bonding or other conventional assembly methods.

The first lend element 18, with a focal length f1, provides most of the focusing power by satisfying the condition that the ratio of f1/f0 is in the range of 0.5 to 2.0, while the second and third lens elements 20 and 22 provide aberration compensation to correct for any optical aberrations present in element 18 and focuses a ray passing through the center of the aperture stop to strike the image plane 14 at a reduced angle of incidence.

The first lens element 18 can be either plastic or glass. While a plastic element in general allows for a lower manufacturing cost, however, a glass element is preferred if temperature stability of the lens is to be more important. In a preferred embodiment, the first lens element 18 will be made of a suitable glass material which is temperature insensitive, avoiding any problems resulting from taking the lens between areas at greatly differing temperatures, such as taking the device using the lens into a building on a very hot summer day or a very cold winter day.

The second lens element 20 is an aspheric element made of molded plastic or glass. The second lens element 20 functions to correct the optical aberrations of the first lens element 18 and the third lens element 22.

The third lens element 22 has a convex first surface and a substantially flat second surface. The element power is positive which reduces the angle of incidence of off-axis ray on the image plane. The third lens element second surface 62 is substantially flat and the preferred embodiment uses an IR coating on the third lens element second surface to produce a lens with an integrated IR cut-off function. The third lens element 22 can also be aspherical and can be made of either glass or plastic.

Electronic imagers today have significant spectral response above the visible range of 400-700 nm. For digital camera applications, tests have shown best performance is obtained by limiting the spectral band-pass of the optics to a range from 400 nm to about 700 nm by using an interference coating referred to as an IR cut-off coating. The IR cut-off coating is typically formed on the surface of a lens with multiple layers of optical material, each layer having its own specific index of refraction and its own thickness. The filter is structured to transmit light within its spectral band and to reflect light outside the spectral band. The design theory and practice of IR coatings of this type is available in texts such as “Thin-Film Optical Filters” by H. A. Macleod. The third edition with 672 pages was published in June 2000 by the Institute of Physics Publishing and is identified by its ISBN: 0750306882.

Applying the coating directly to the second surface 46 provides a more compact lens design and reduces the cost of the whole product by the elimination of a separate component, such as a coated plate. A cost saving advantage of the present invention is that the IR coating can be directly applied to the substantially flat third lens element second surface 62. The material and substantially flat shape of the third lens element second surface 62 is conveniently compatible with the IR cut-off filter coating process. If the surface to be coated was not substantially flat, the coating would tend to not be uniform with the result that the filtration properties of regions on the surface of the filter would vary across its surface. In addition, the use of glass eliminates any problem with distortion or melting from the use of elevated temperatures during the coating process. If the material used were to be plastic, the lens element might deform or melt during the coating process. A design is presented herein that is believed to be compatible with the application of an IR cut-off coating and the process used for its application.

A preferred embodiment of the present invention is shown in Table 1 and Table 2. Table 1 shows the surface structure of lens assembly starting from the object side. The object surface 14 is shown as “OBJECT, 14” in column 1 row 3. The image plane 16 is shown as “Image Plane, 16” in column 1 last row. The first lens element 18 is defined by Surface Number 50 and Surface Number 58 which is also near the location of the aperture stop plane of this lens. The material for this element has a refractive index of 1.618 at d-line at 587 nm. The Abbe number of the material is 63.4. The first surface 50 of this element has a radius of 1.64 mm while the second surface 3.29 mm. The center thickness of this element is 1.49 mm. The vertex spacing from this element to the second lens element 20 is shown as 0.64 mm. The properties of other two elements are interpreted in a similar fashion.

TABLE 1
Surface Description of Embodiment

| Surface Number | Type | Radius | Thickness | Nd | Abbe |
|---|---|---|---|---|---|
| OBJECT, 14 | STANDARD | Infinity | Infinity | | |
| 50 | STANDARD | 1.64 | 1.49 | 1.618 | 63.4 |
| 58(STO) | STANDARD | 3.29 | 0.64 | | |
| 52 | EVENASPH | −2.28 | 1.34 | 1.689 | 31.2 |
| 60 | EVENASPH | −5.68 | 0.10 | | |
| 54 | STANDARD | 5.88 | 1.22 | 1.801 | 44.3 |
| 62 | STANDARD | 8582.37 | 1.21 | | |
| IMAGE PLANE, 16 | STANDARD | Infinity | | | |

TABLE 2
Aspheric coefficients for surfaces of element 2
1st Surface of Element 2 (surface 52)

| | |
|---|---|
| D | −0.079282116 |
| E | −0.19307826 |
| F | 0.48564859 |
| G | −0.71896107 |
| H | 0 |
| I | 0 |

2nd Surface of Element 2 (surface 60)

| | |
|---|---|
| D | −0.002466236 |
| E | −0.010260173 |
| F | 0.002754689 |
| G | −0.000681387 |
| H | 0 |
| I | 0 |

The terms such as “spherical”, “conic”, and “general asphere” are used herein in the claims are to be interpreted in accordance with their conventional meanings in terms of a lens surface equation such as in Equation 1 below. The legend EVENSPH that appears in Tables 1 with column heading “TYPE” requires that the surface be characterized by an even ordered polynomial. The legend STANDARD implies that the surface is spherical in character and is not an aspherical surface. Equation 1 provides the sag or surface displacement “z” measured from a plane passing through a surface vertex of the lens, the plane being normal to the optical axis.

$$z = \frac{c {y}^{2}}{{1 + [ 1 - ( 1 + k ) {c}^{2} {y}^{2} ] ]}^{1 / 2}} + {Dy}^{4} + {Ey}^{6} + {Fy}^{8} + {Gy}^{10} + {Hy}^{12} + {Iy}^{14} \qquad Eq . 1$$

The distance “z” is measured at a distance or radius “y” from the optical axis 46 of the lens assembly 10. The coefficient “c” is the curvature of the lens at the optical axis and it is equal to the reciprocal of the radius. The coefficient “k” is a conic constant. A surface is spherical if “k” and “D” through “I” are all zero. A surface is an aspherical surface if either “k” or any of the coefficients “D” through “I” are non-zero.

At least one of the surfaces of the second lens element 20 must have an aspherical profile. In Table 1, the first and second surfaces of the second lens element 20 are shown to have an aspheric profile. The polynomial coefficients (D to I) for both surfaces are given in Table 2. The conic constant “k” is zero for both surfaces.

The first surface of the third lens is STANDARD or spherical in the embodiments of Tables 1; however, although not shown in the tables, the first surface of the third lens can be aspherically corrected from flat in alternative embodiments. The second surface of the third lens element 22 in both Table 1 is shown as a substantially flat surface.

If the first, second and or third lens elements are to have an aspherical surface, and if cost is to be reduced, the first, second and third lens elements 18, 20 and 22 respectively, should be made from a material such as plastic using a manufacturing technique that is suitable for producing an aspheric surfaces. If the material is plastic, precision molding can be used. If the material is glass, a glass molding process must be employed. As explained above, the second lens element 20 and the third lens element 22 are believed to provide most of the aberration correction of the objective. Therefore, it is believed that the use of plastic material for the second and third lens element 22 will have a minimal impact on the focus stability of the lens assembly 10 within the optical imager assembly 44 even though the plastic material to be used would be more sensitive to environmental conditions than glass.

The lens assembly 10 within the optical imager assembly 44 of the present invention has a very short lens height or TT, dimension 60, relative to the size of the image, DI, that it provides. An electronic camera using an objective lens such as lens assembly 10 forms an image 48 on the active surface 36 of the electronic imager 28. Bracket 48 on the image plane 16 schematically identifies the limits of the image formed on the active surface 36 and therefore, the limits of image plane 14. As stated above, the electronic imager 28 is typically a CCD or CMOS imager. The effective imaging area of the electronic imager 28 is typically a rectangular area with a diagonal size that equal to the dimension DI. To provide a rectangular image and to achieve acceptable image quality, the lens must provide a circular image area with a diameter equal or greater than DI.

As explained above, the lens height or total track (TT) shown along the lens frame or housing 24 at the base of FIG. 1 is defined as the distance from the first lens surface vertex 74 to the image plane 14. The “compactness” of the optical imager 10 is defined as the ratio of TT to DI. As this ratio is reduced, the resulting lens is shorter and more appealing for use in hand held appliances. For prior art lens designs, this ratio is believed to be greater than 1.5. However, the objective lens of the present invention obtains an improvement in this ration such that the ration of TT/DI<1.5. With the ratio of TT/DI<1.5, the optical imager assembly 44, which includes the lens assembly 10, is considered to be a low profile optical imager which makes it suitable for compact digital camera modules such as those used in cell phones. The use of the lens assembly 10 of the present invention of FIG. 1 in combination with suitable a selection of material and the surface prescriptions for each element in correspondence with Tables 1 and 2 achieves an optical imager assembly 44 with excellent image quality.

While certain specific relationships, materials and other parameters have been detailed in the above description of preferred embodiments, those can be varied, where suitable, with similar results. Other applications, variation and of the present invention will occur to those skilled in the art upon reading the present disclosure. Those variations are also intended to be included within the scope of this invention as defined in the appended claims.

1. A lens assembly having a focal length f0 comprising:
a first lens element with focal length f1>0 having a first and second surfaces the first surface being convex and facing object space,
a second lens element having a first and second surface, the first surface being a concave surface facing the first lens element second surface, the second surface being an aspheric surface, and
a third lens element having a first and second surface and a positive power, the first surface being convex facing the second lens element second surface having a radius of r1, the third lens element second surface having a radius of r2, the third lens element's first and second surfaces being shaped such that |r2|>|r1|,
the first, second and third lens elements being shaped and coaxially positioned on an optical axis to obtain a ratio of f1/f0 such that 0.5<f1/f0<2.0.

2. The lens assembly of claim 1 wherein the first lens element second surface has a concave shape.

3. The lens assembly of claim 1 wherein the first lens element is made of glass material.

4. The lens assembly of claim 1 claim 1 wherein the third lens element second surface is flat.

5. The lens assembly of claim 1 wherein the third lens element is made of glass material.

6. The lens assembly of claim 1 wherein the third lens element second surface is coated with an IR cut-off interference coating.

7. A lens assembly in a digital camera, the combination comprising:
a camera body,
an electronic imager coupled to the camera body, said electronic imager having
an active surface, an image plane being formed on the active surface with a maximum effective dimension DI,
the lens assembly with a focal length f0 and having,
a first lens element with focal length f1 with f1>0 and having a first and second surfaces, the first surface being convex,
a second lens element having a first and second surface, the first surface being a concave surface facing the first lens element second surface, the second surface being an aspheric surface, and
a third lens element having a first and second surface with positive power, the first surface being convex having a radius of r1, the second surface having a radius of r2,
the first, second and third lens elements being coaxially aligned and positioned on an optical axis normal to the image plane, the distance from the first lens first surface to the image plane being TT (the lens height), the lens elements being shaped and positioned such that 0.5<f1/f0<2.0, |r2|>|r1|, and TT/DI<1.5

8. The lens assembly of claim 7 wherein the first lens element second surface has a concave shape.

9. The lens assembly of claim 7 wherein the first lens element is made of glass material.

10. The lens assembly of claim 7 claim 1 wherein the third lens element second surface is flat.

11. The lens assembly of claim 7 wherein the third lens element is made of glass material.

12. The lens assembly of claim 7 wherein the third lens element second surface is coated with an IR cut-off interference coating.

13. The lens assembly of claim 1 wherein the first, second and third lens elements are shaped to conform to the prescription of the following Table 1 and table 2 as follows:
TABLE 1
Surface Description of Embodiment

| Surface Number | Type | Radius | Thickness | Nd | Abbe |
|---|---|---|---|---|---|
| OBJECT, 14 | STANDARD | Infinity | Infinity | | |
| 50 | STANDARD | 1.64 | 1.49 | 1.618 | 63.4 |
| 58(STO) | STANDARD | 3.29 | 0.64 | | |
| 52 | EVENASPH | −2.28 | 1.34 | 1.689 | 31.2 |
| 60 | EVENASPH | −5.68 | 0.10 | | |
| 54 | STANDARD | 5.88 | 1.22 | 1.801 | 44.3 |
| 62 | STANDARD | 8582.37 | 1.21 | | |
| IMAGE PLANE, 14 | STANDARD | Infinity | | | |

TABLE 2
Aspheric coefficients for surfaces of element 2
1^{st} Surface of Element 2 (surface 52)

| | |
|---|---|
| D | −0.079282116 |
| E | −0.19307826 |
| F | 0.48564859 |
| G | −0.71896107 |
| H | 0 |
| I | 0 |

2nd Surface of Element 2 (surface 60)

| | |
|---|---|
| D | −0.002466236 |
| E | −0.010260173 |
| F | 0.002754689 |
| G | −0.000681387 |
| H | 0 |
| I | 0 |

14. A lens assembly in a digital camera, the combination comprising:
a camera body,
an electronic imager coupled to the camera body, said electronic imager having an active surface,
an image plane being formed on the active surface with maximum effective dimension DI,
the lens assembly having;
a first lens element having a positive power,
a second lens element and
a third lens element, each respective lens element having a first and second surface, the first lens element first surface facing object space,
the second lens element first surface facing the first lens element second surface,
the third lens element first surface facing the second lens element second surface,
each respective lens element being coaxially positioned on an optical axis, the optical axis being perpendicular to the image plane, TT (the height of the lens assembly), being the distance from the first lens element first surface to the image plane, the first, second and third lens elements being shaped and sequentially positioned along the optical axis to obtain a ratio of TT/DI that is less than 1.5, as an image of an object is formed on the image plane.

15. The lens assembly lens assembly of claim 14 wherein:
the lens assembly has a focal length f0,
the first lens element first surface is convex in shape.

16. The lens assembly of claim 15 wherein the first lens element second surface is concave in shape and wherein the ratio of f1 to f0 is in a range such that 0.5<f1/f0<2.0

17. The lens assembly of claim 16 wherein the second lens element first surface is concave in shape.

18. The lens assembly of claim 17 wherein the second lens element second surface is aspheric in shape.

19. The lens assembly of claim 18 wherein the third lens element first surface is convex in shape, the third lens element having a positive power, the first surface having a radius of r1, the second surface having a radius of r2 and wherein |r2|>|r1|.

20. The lens assembly of claim 14 wherein: the lens assembly is characterized as having a focal length f0 and having,
a first lens element with focal length f1 with f1>0, the first lens element having
a first and second surfaces the first surface being convex,
a second lens element, the second lens element being a meniscus lens element having a first and second surface, the first surface being concave surface facing the first lens element second surface, the second surface being an aspheric surface, and
a third lens element having a first and second surface with a positive power, the first surface having a radius of r1, the second surface having a radius of r2, the first, second and third lens elements being coaxially aligned and positioned on an optical axis normal to the image plane to form an image of the object on the image plane, the distance from the first lens first surface to the image plane being TT (the lens height), the lens elements being shaped and positioned such that 0.5<f1/f0<2.0, and |r2|>10x|r1|
